(19) United States
(12) Patent Application Publication
(10) Pub. No.: US 2026/0054718 A1
(43) Pub. Date: Feb. 26, 2026

(54) SELECTIVE AND SCALABLE SENSOR FUSION FOR AUTONOMOUS EMERGENCY BRAKING

(71) Applicant: QUALCOMM Incorporated, San Diego, CA (US)

(72) Inventor: Mustafa KESKIN, San Diego, CA (US)

(21) Appl. No.: 18/814,039

(22) Filed: Aug. 23, 2024

(51) Int. Cl. B60W 30/09; B60W 10/18; B60W 30/095; G06N 3/04

(52) U.S. Cl. CPC B60W 30/09; B60W 10/18; B60W 30/0956; G06N 3/04

(57) ABSTRACT

Disclosed are techniques for selective and scalable sensor fusion for autonomous emergency braking (AEB). In an aspect, an AEB system on a vehicle dynamically selects one or more vehicle sensors from a plurality of vehicle sensors and/or dynamically scales an output from each of the dynamically selected one or more vehicle sensors based on one or more factors, such as the condition of the vehicle, weather, road, or traffic, a location of the vehicle, a sensor capability, a required sensing accuracy, etc., or a change of any of the above. The AEB system monitors a forward path of travel of the vehicle for potential collisions, based on data comprising the output from the one or more vehicle sensors. If a potential collision is detected, the AEB system autonomously applies vehicle brakes to avoid the potential collision. The AEB system can use data and location fingerprinting to reduce false positives.

### BACKGROUND OF THE DISCLOSURE

### 1. Field of the Disclosure

Aspects of the disclosure relate generally to autonomous operation of motor vehicles and more specifically to autonomous emergency braking.

### 2. Description of the Related Art

Since 1970, due primarily to technical innovations such as safety seat belts, antilock braking systems (ABS), airbags, electronic stability control (ESC) systems, automatic collision control (ACC) systems, lane departure warning (LDS) systems, etc., the number of road traffic fatalities per year has steadily decreased.

FIG. 1 is a graph showing the number of traffic fatalities per year in Germany along with dates in which various automotive safety features were adopted. During that time, motor vehicles have gone from having no onboard processing capability to having a plethora of microprocessors and other control circuitry.

One of the more recent additions is the autonomous emergency braking (AEB) system, which autonomously engages the brakes of a vehicle upon detection of a possible impending collision with an obstacle or other vehicle in the line of travel. AEB systems use a vehicle's braking system to avoid collisions without input from the driver, e.g., without requiring the driver to press on the brake pedal.

Not all passenger vehicles use all of these systems. According to the Federal Statistics Office of Germany, in 2019 more than half of all passenger vehicle crashes involved other road users, which include cars, trucks, motorcycles, bicycles, and pedestrians. The use of an AEB system might have avoided some of these collisions.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of autonomous emergency braking (AEB) performed by a vehicle includes performing, based on one or more factors, at least one of: dynamically selecting one or more vehicle sensors from a plurality of vehicle sensors, or dynamically scaling an output from one or more selected vehicle sensors; and monitoring a forward path of travel of the vehicle for potential collisions, based on data comprising the output from the one or more dynamically selected and/or scaled vehicle sensors.

In an aspect, an autonomous emergency braking (AEB) system includes a plurality of vehicle sensors; one or more memories; one or more transceivers; and one or more processors communicatively coupled to the one or more memories and the one or more transceivers, the one or more processors, either alone or in combination, configured to: perform, based on one or more factors, at least one of: dynamically selecting one or more vehicle sensors from a plurality of vehicle sensors, or dynamically scaling an output from one or more selected vehicle sensors; and monitor a forward path of travel of the vehicle for potential collisions, based on data comprising the output from the one or more dynamically selected and/or scaled vehicle sensors.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a graph showing the number of traffic fatalities per year in Germany along with dates in which various automotive safety features were adopted.

FIG. 2 illustrates the generic operation of an AEB system.

FIG. 3 is a graph showing an example autonomous braking profile that may be employed by a conventional AEB system.

FIG. 4 is a block diagram illustrating an AEB system with selective and scalable sensor fusion, according to aspects of the disclosure.

FIG. 5 is a graph showing an example autonomous braking profile that may be employed by the AEB system, according to aspects of the disclosure.

FIG. 6 is a block diagram illustrating an AEB system with selective and scalable sensor fusion, according to aspects of the disclosure.

FIG. 7 is a graph showing an example autonomous braking profile that may be employed by the AEB system, according to aspects of the disclosure.

FIG. 8 is a flow chart illustrating an example process performed by an AEB system according to aspects of the disclosure.

FIG. 9 illustrates an AEB system in accordance with some examples of the disclosure.

FIG. 10 illustrates various electronic devices that may be integrated with any of the aforementioned AEB circuitry in accordance with various examples of the disclosure.

FIG. 11 is a flow chart illustrating an example process performed by an AEB system, according to aspects of the disclosure.

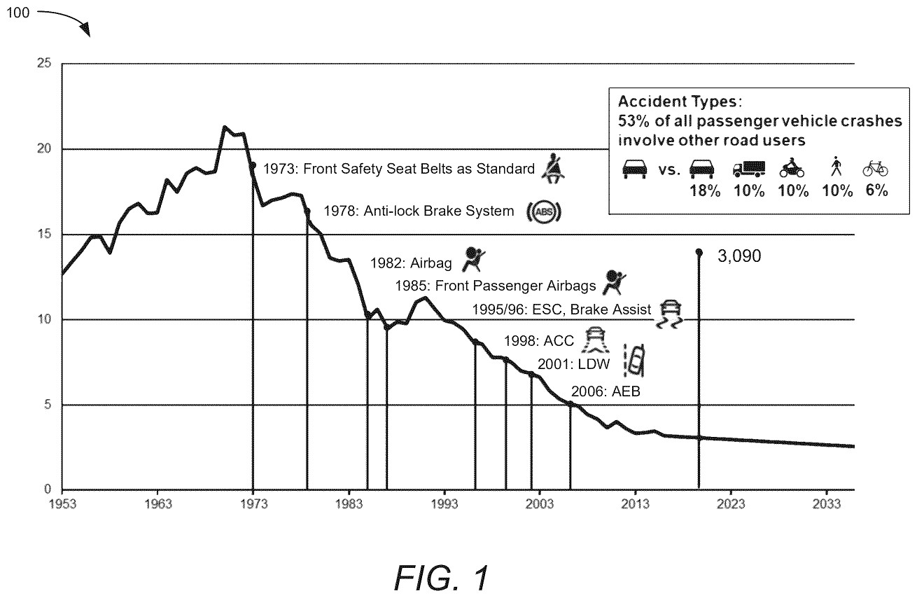

### DETAILED DESCRIPTION

Disclosed are techniques for selective and scalable sensor fusion for autonomous emergency braking (AEB). In an aspect, an AEB system on a vehicle dynamically selects one or more vehicle sensors from a plurality of vehicle sensors and/or dynamically scales an output from each of the dynamically selected one or more vehicle sensors based on one or more factors. The AEB system detects a potential collision of the vehicle with an object in a forward path of travel of the vehicle based on data comprising the dynamically scaled outputs from the one or more dynamically selected vehicle sensors, and autonomously applies vehicle brakes to avoid the potential collision.

In order to prevent false autonomous braking events, the selection and scaling of each sensor can be independently adjusted based on various factors. Example factors include, but are not limited to, the car's condition, such as whether it is parked or speeding, environmental conditions, the car's location, the speed and condition of the road, the latency of data processing of a particular sensor, the time of flight of a particular sensor, the health of a particular sensor, the particular driver, the level of accuracy required per operation, and other factors. In some aspects, a single-layer sensor fusion approach is especially beneficial for quick response times. This approach functions like a single neuron layer with individual or independent activations. Multiple layers can be implemented, with the bypass operation of multiple stages enabled depending on the speed of the car or the time of flight. The type of non-linearity for each sensor can be optimized with training during car usage. The internal operations of each sensor domain are flexible, and the final stage determines the time-to-collision.

In some aspects, user feedback and data or location fingerprinting can be used to optimize the system after a false positive occurs. With user input, the system can fingerprint the location or event, providing a closed-loop feedback mechanism to optimize selection and/or scaling factors. For example, the scaling of angular sensors can be increased, allowing the system to identify the location and reduce false positives from neighboring lanes. In a parking situation, the system may entirely scale down the outputs of some sensors. In some aspects, analysis and processing of sensor data after the event may also indicate a false positive event with a certain confidence level, similar to unsupervised learning. Such information can be also used for additional tuning of the overall system.

Particular aspects of the subject matter described in this disclosure can be implemented to realize one or more of the following potential advantages. In some aspects, by dynamically selecting and scaling the sensor inputs, the described techniques can be used to reduce AEB false positives. In some aspects, location and/or event fingerprinting information can be used by a vehicle to avoid false positives in the future. In some aspects, location and/or event fingerprinting information can be provided to a network entity, which can in turn distribute this information to other vehicles so that they, too, can avoid false positives in the future. In some aspects, the AEB system can utilize location and event fingerprinting to optimize selection and scaling of the sensor inputs accordingly. Even after an event has happened, the AEB system can use data collected during the event to run different scenarios with continuous training (or additional training) to improve the accuracy of the prediction.

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In 2023 the United States Department of Transportation's National Highway Traffic Safety Administration announced plans to require AEB and pedestrian AEB systems on passenger cars and light trucks.

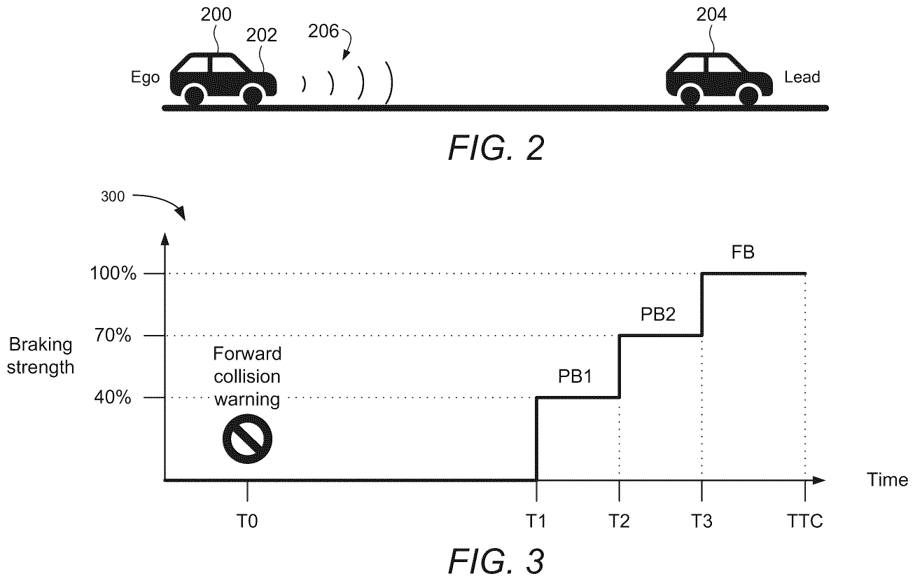

FIG. 2 illustrates the generic operation of an AEB system. In the example shown in FIG. 2, a first vehicle 200 having an AEB system 202 detects the presence of a possible obstacle, in this example a second vehicle 204, via on-board sensors. For example, the first vehicle 200 may send radar or other RF signals 206 which reflect off of the second vehicle 204. The first vehicle 200 may have an on-board visible light camera, infrared (IR) sensor, or other sensor that detects the presence of obstacles in the path of travel.

FIG. 3 is a graph 300 showing an example autonomous braking profile that may be employed by a conventional AEB system. Graph 300 illustrates the amount of braking strength that may be applied by the AEB system over time, starting with the detection of a possible forward collision, e.g., by the onboard sensors, at time TO. In the example shown in FIG. 3, the AEB system waits until time T1 before autonomously applying brakes, e.g., to give the driver of the vehicle a chance to respond to the warning and apply the brakes first. At time T1, the AEB system applies a first braking strength. labeled partial braking 1 (PB1) in graph 300. At time T2, the AEB system applies a higher braking strength, labeled partial breaking 2 (PB2) in graph 300. At time T3, the AEB system applies full braking (FB) strength at time T3. The times T1, T2, and T3 are calculated by the AEB system to allow the vehicle to come to a complete stop before the time to collision (TTC). In the example shown in FIG. 3, PB1 applies 40% of full braking strength, PB2 applies 70% of full braking strength, and FB is 100% of braking strength, but these percentages are for illustration only.

Because a false negative (failing to autonomously brake to avoid a collision) by an AEB is potentially catastrophic, AEB systems are designed to strongly avoid false negatives. However, this can create a tendency to suffer a false positive (autonomously braking when there is no reason to do so), which can be equally dangerous if, for example, the AEB system brings the vehicle to a complete stop in the middle of a busy traffic lane when there is no obstacle present: because there is no actual obstacle, other drivers have no reason to expect the vehicle in front of them to suddenly stop for no reason, and may not be able to react in time to avoid a collision with the abruptly-stopped vehicle. Moreover, the driver of the vehicle whose AEB suffered the false positive may experience, confusion, panic, stress, or even fear during the sudden, unexpected deceleration, and may also suffer physical injury (sprain, bruise, contusion, etc.) as a result of the unexpected change in vehicle velocity.

While there are various reasons why an AEB system may experience a false positive, one reason may be that various sensors have different levels of accuracy at different ranges from the sensor, and some sensors are sensitive to environmental conditions. For example, a visible light camera may provide excellent detection of potential obstacles during clear weather and daylight but be greatly hampered by precipitation, fog, or darkness (e.g., at night, in tunnels, etc.). In another example, an IR sensor may provide very accurate readings in conditions that hamper visible light cameras, but may have a much limited range compared to a visible light camera. In yet another example, a radar may provide accurate results on the open highway with few vehicles but may have lower accuracy in scenarios where there are many reflecting objects such as buildings and heavy traffic.

Conventional AEB systems with multiple sensors and multiple sensor types may suffer from the problem that some sensor types may provide erroneous or ambiguous input into the AEB system under some conditions, which may trigger a false positive by the AEB system. Thus, there is need for AEB systems that can intelligently use sensors in a manner that considers each sensor type's individual strengths and weaknesses, e.g., to dismiss, ignore, or treat with skepticism input from sensors that might provide erroneous data under the current conditions.

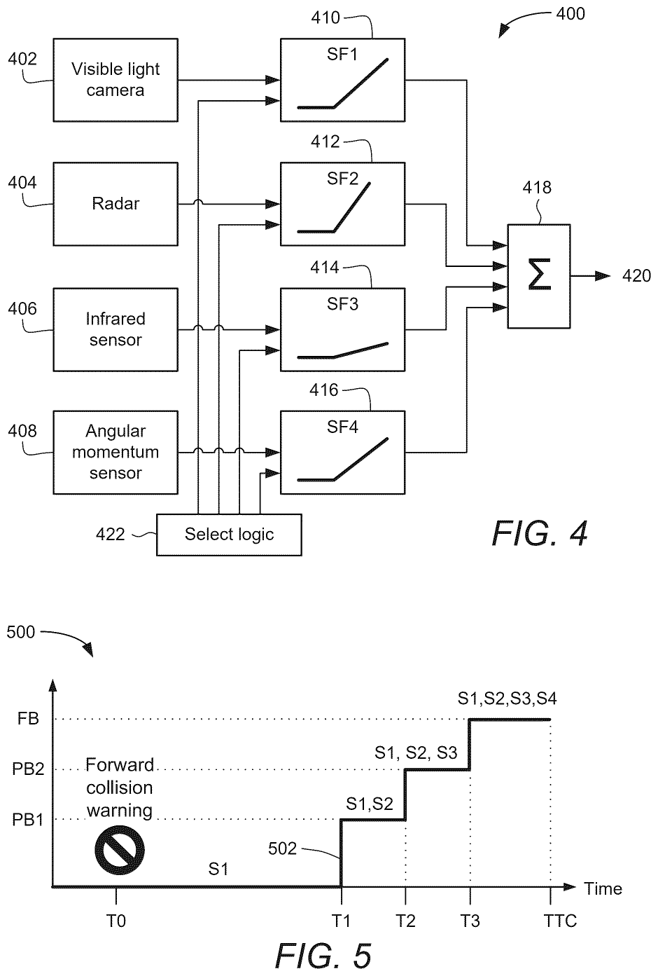

FIG. 4 is a block diagram illustrating an AEB system 400 with selective and scalable sensor fusion, according to aspects of the disclosure. In the example shown in FIG. 4, the AEB system 400 includes a visible light camera 402, a radar 404, an infrared sensor 406, and an angular momentum sensor 408. The output of each sensor goes to its own scaling function (SF), i.e., with the output of the visible light camera 402 being scaled by SF1 410, the output of the radar 404 being scaled by SF2 412, the output of the infrared sensor being scaled by SF3 414, and the output of the angular momentum sensor 408 being scaled by SF4 416. The outputs of the scaling functions are provided to a summing block 418, the output 420 of which corresponds to a braking strength (or is provided to circuitry that calculates the braking strength). A select logic block 422 controls which scaling functions are active and provide input to the summing block 418 and which scaling function are inactive and do not provide input to the summing block 418.

The collection of sensors shown in FIG. 4 is illustrative and not limiting. Other types of sensors, and other collections of sensor types, may also or alternatively be used. In some aspects, the AEB system 400 can evaluate outputs of these or other sensors before and after the event, and consecutively run cross correlation, F-test, or other machine learning methods to evaluate which other sensors' data may be a significant identifier of the event and therefore should also be included in the AEB system 400.

FIG. 5 is a graph 500 showing an example autonomous braking profile 502 that may be employed by the AEB system 400, according to aspects of the disclosure. Graph 500 illustrates the amount of braking strength that may be applied by the AEB system 400 over time, starting with the detection of a possible forward collision, e.g., by the onboard sensors, at time TO. Graph 500 also illustrates which sensors provide inputs to the summing block 418 at particular times. In graph 500, the sensors are generically labeled S1, S2, S3, and S4, and may be mapped to different sensors based on particular implementations. For example, in one implementation, S1 may correspond to the radar 404 in FIG. 4, S2 may correspond to the angular momentum sensor 408 in FIG. 4, S3 may correspond to the visible light camera 402 in FIG. 4, and S4 may correspond to the infrared sensor 406 in FIG. 4. In another implementation, S1 through S4 may correspond to the sensors in FIG. 4 in a different order than the one just described.

In the example shown in FIG. 5, sensor S1 provides the only input to the summing block 418 until time T1. At time T1, the input from sensor S2 is also provided to the summing block 418. At time T2, the input from sensors S3 and S4 is also provided to the summing block 418. At time T3, the input from sensor S4 is also provided to the summing block 418. Thus, in the example shown in FIG. 5, the input from sensor S4 is not considered until time T3, at which time the AEB system determines that full braking is needed to avoid a collision. The autonomous braking profile shown in FIG. 5 is illustrative and not limiting; other autonomous braking profile shapes may be produced by the AEB system 400, e.g., having a greater or lesser number of time trigger points, having a greater or lesser number of partial braking strengths, etc.

For example, in some aspects, the selection of sensor inputs to use, each sensor input's scaling amount, or both, may be based on one or more pieces of information including, but not limited to, a current condition of the vehicle (e.g., parked, stopped, moving, speeding), the latency of data processing on a particular sensor, a time of flight for a particular sensor, an accuracy level needed per each operation, environmental conditions (e.g., temperature, precipitation, etc.), or other factors. For example, input from a visible light camera may be given lower importance (reduced scaling factor) or ignored entirely (deselected) during weather conditions that hamper forward visibility, such as rain, fog, etc.

Although graph 500 shows an AEB profile that results in application of full braking to avoid a collision, it will be understood that, depending on the specific conditions, the AEB system may not need to apply any of the autonomous braking strengths (e.g., PB1, PB2, and FB), such as when an obstacle moves out of the way (e.g., a large truck that blocked an intersection passes through the intersection before the sensing vehicle enters that intersection). In such situations, it may be said that the time to collision becomes infinity, and thus, the AEB trigger points T1, T2, and T3 also move to infinity, with the result that PB1, PB2, and FB are not triggered (if they have not already been triggered).

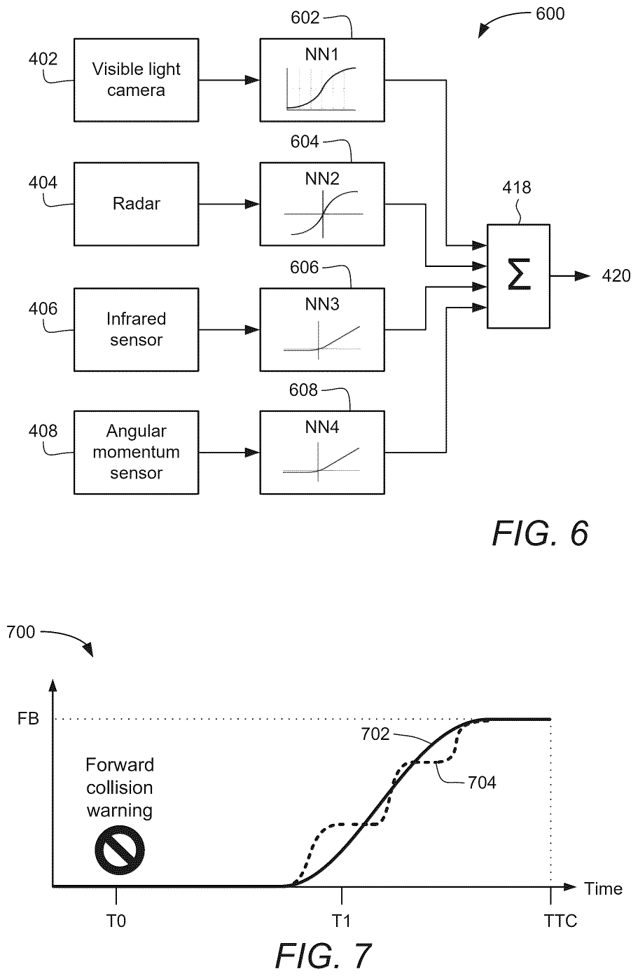

FIG. 6 is a block diagram illustrating an AEB system 600 with selective and scalable sensor fusion, according to aspects of the disclosure. In the example shown in FIG. 6, the AEB system 600 includes a visible light camera 402, a radar 404, an infrared sensor 406, an angular momentum sensor 408, and a summing block 418, the output 420 of which corresponds to a braking strength (or is provided to circuitry that calculates the braking strength). Like-numbered elements are essentially identical to the correspondingly-numbered elements in FIG. 4, and thus their descriptions will not be repeated here. Unlike the AEB system 400 in FIG. 4, however, the AEB system 600 includes neural networks (NNs), each of which processing an output of one of the sensors. Thus, in FIG. 6, a first neural network (NN1) 602 processes the output of the visible light camera 402, a second neural network (NN2) 604 processes the output of the radar 404, a third neural network (NN3) 606 processes the output of the infrared sensor 406, and a fourth neural network (NN4) 608 processes the output of the angular momentum sensor 408. The outputs of the neural networks are provided to the summing block 418. In some aspects, the summed data output 420 is used to calculate a projected time to collision (TTC). In some aspects, the AEB system 600 uses the calculated TTC to calculate a time T1 before the TTC at which to autonomously apply the vehicle's brakes.

In some aspects, the neural networks may be implemented as single layer neural networks, which may provide faster response to emergency situations. In some aspects, the neural networks may comprise single neuron layers with individual or independent activations. In some aspects, the neural networks may be implemented as multiple-layer neural networks; in some aspects, one or more layers of the multiple-layer neural network may be bypassed in particular circumstances, e.g., based on the current speed of the vehicle, the time of flight of a sensor reading, etc. Neural networks have the advantage that per-sensor non-linearities can be optimized with training during vehicle usage. The combination of the outputs of the neural networks to

FIG. 7 is a graph 700 showing an example autonomous braking profile 702 that may be employed by the AEB system 600, according to aspects of the disclosure. Graph 700 illustrates the amount of braking strength that may be applied by the AEB system 600 over time, starting with the detection of a possible forward collision, e.g., by the onboard sensors, at time TO. In one implementation, the output of the AEB system 600 provides an autonomous braking profile 702 that smoothly increases the braking strength over time. In another implementation, the output of the AEB system 600 provides an autonomous braking profile 704 that is shaped more like a step-wise function. The autonomous braking profiles shown in FIG. 7 are illustrative and not limiting; other autonomous braking profile shapes may be produced by the AEB system 600, e.g., having a greater or lesser number of time trigger points, having a greater or lesser number of partial braking strengths, having a different continuous curve shape, etc.

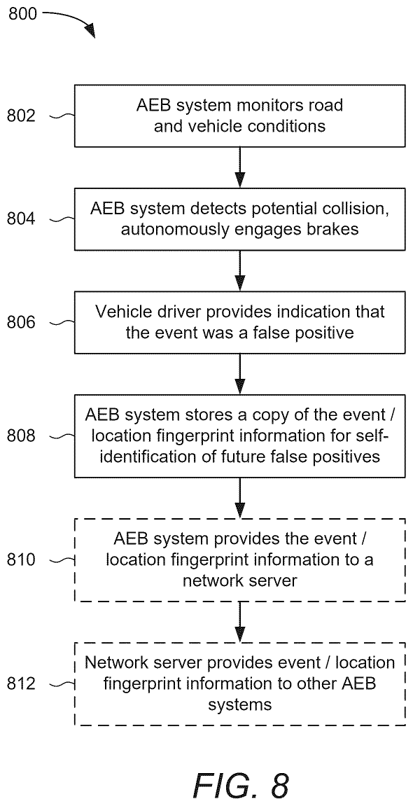

False positives may happen due to particular features of a road, such as curves, ramps, turns, multiple road layers, unusual medians or barriers, complicated or unusual traffic patterns, etc. In some aspects, the AEB system 600 is provided with information about locations at which a false positive has occurred or is likely to occur. In some aspects, these locations may be identified by user input or feedback, e.g., provided after a false positive has occurred. The AEB system 600 may record the geographic location(s) at which and/or condition(s) during which a user-identified false positive occurred, which may be referred to as “fingerprinting” the location or event. This provides the AEB system 600 with closed-loop feedback, which can be used to optimize sensor selection and/or scaling. For example, scaling of angular sensors can be increased at locations known to have false positives due to traffic coming from neighboring lanes. In another example, outputs from some sensors may be ignored or scaled down when the vehicle is moving in a manner similar to behavior in a parking lot, or when the vehicle is in a location known to be a parking lot. In some aspects, this information can be provided to a network server or service so that this information can be provided to other AEB systems 600. An example of this is shown in FIG. 8.

FIG. 8 is a flow chart 800 illustrating an example process performed by an AEB system according to aspects of the disclosure. In the example shown in FIG. 8, at block 802, the AEB system monitors road and vehicle conditions. In some aspects, the AEB system may maintain a running record of vehicle and road conditions, which may be referred to herein as “monitoring data.” In some aspects, the AEB system may keep only the last X number of seconds of monitoring data, e.g., in a circular buffer, first-in first-out (FIFO) buffer, etc., and discard data older than X seconds. At block 804, the AEB system detects a potential collision, and autonomously engages the vehicle's brakes.

In the example shown in FIG. 8, the AEB generated a false positive, so at block 806, the vehicle driver provides some indication to the AEB system that the event was a false positive. For example, the driver may press a button on the steering wheel, control stalks, dashboard, or console of the vehicle, or may speak a voice command that the vehicle understands as indicating a false positive, or other method of providing such indication to the AEB system. At block 808, in response to receiving the indication that the autonomous braking event was a false positive, the AEB system stores a copy of event/location fingerprint information. In some aspects, the fingerprint information may include some or all of the data being monitored (e.g., speed, inertial data, visual data, radar data, etc.). In some aspects, the fingerprint information may include data from a window of some number of seconds Y before the moment of receiving the indication of false positive up to or around the moment of receiving the indication of false positive. In some aspects, the AEB system stores this information for its immediate and future use, e.g., to help detect and avoid future false positives.

In the example shown in FIG. 8, at optional block 810, the AEB system may provide this event/location fingerprint information to a network server or service, and at optional block 812, the network server or service may provide this event/location fingerprint information to other AEB systems, which can use this information to help detect and avoid false positives.

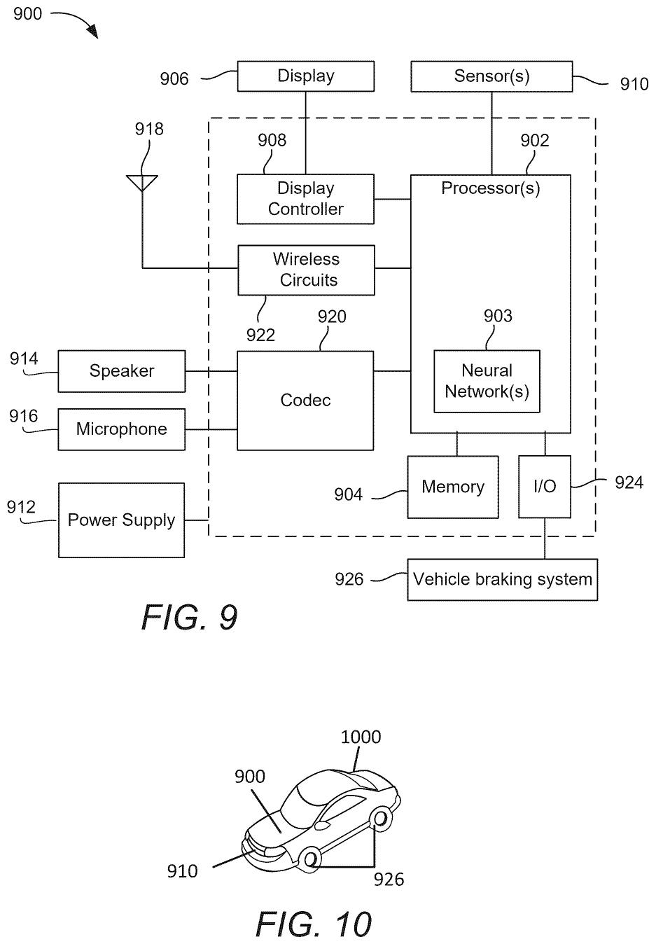

FIG. 9 illustrates an AEB system 900 according to aspects of the disclosure. In some aspects, the AEB system 900 may be implemented by including one or more integrated circuit (IC) devices manufactured based on the examples described in this disclosure.

In some aspects, AEB system 900 may be configured as a wireless communication device. As shown, AEB system 900 includes processor(s) 902. In some aspects, the processor(s) 902 may optionally include or optionally communicate with one or more neural network(s) 903. Processor(s) 902 may be communicatively coupled to memory 904 over a link, which may be a die-to-die or chip-to-chip link. AEB system 900 also includes display 906 and display controller 908, with display controller 908 coupled to processor(s) 902 and to display 906. The AEB system 900 may sensors 910 (e.g., visible light or IR sensors, radar, angular momentum sensors, etc.), power supply 912 (e.g., battery), speaker 914, microphone 916, and wireless antenna 918. In some aspects, the power supply 912 may directly or indirectly provide the supply voltage for operating some or all of the components of the AEB system 900.

In some aspects, FIG. 9 may include coder/decoder (CODEC) 920 (e.g., an audio and/or voice CODEC) coupled to processor(s) 902; speaker 914 and microphone 916 coupled to CODEC 920; and wireless circuits 922 (which may include a modem, RF circuitry, filters, etc.) coupled to wireless antenna 918 and to processor(s) 902.

In some aspects, one or more of processor(s) 902, display controller 908, memory 904, CODEC 920, and wireless circuits 922 may include one or more IC devices including semiconductor structures manufactured according to the examples described in this disclosure.

In some aspects, the one or more processor(s) 902 are coupled to an I/O block 924, which provides a control signal or signals to the vehicle braking system 926, i.e., to autonomously apply emergency braking.

FIG. 10 illustrates an example vehicle 1000 that may include the aforementioned AEB system 900 and sensors 910 to engage a vehicle braking system 926 in accordance with various examples of the disclosure. The vehicle 1000 is merely exemplary. Other apparatuses or devices may also feature the AEB system 900 including manned and unmanned vehicles, public transport, etc.

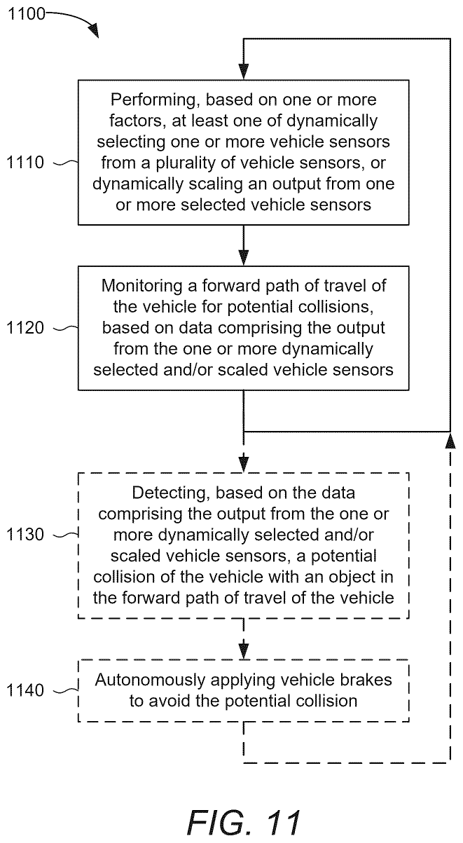

FIG. 11 is a flowchart of an example process 1100 associated with a method of AEB performed by a vehicle, according to aspects of the disclosure. In some implementations, one or more process blocks of FIG. 11 may be performed by an AEB system (e.g., AEB system 400, AEB system 600, AEB system 900). In some implementations, one or more process blocks of FIG. 11 may be performed by another device or a group of devices separate from or including the vehicle. Additionally, or alternatively, one or more process blocks of FIG. 11 may be performed by one or more components of an apparatus, such as a processor(s), memory, or transceiver(s), any or all of which may be means for performing the operations of process 1100.

As shown in FIG. 11, process 1100 may include, at block 1110, performing, based on one or more factors, at least one of dynamically selecting one or more vehicle sensors from a plurality of vehicle sensors, or dynamically scaling an output from one or more selected vehicle sensors Means for performing the operation of block 1110 may include the processor(s), memory, or transceiver(s) of any of the apparatuses described herein. For example, the vehicle may dynamically select one or more vehicle sensors from a plurality of vehicle sensors and/or dynamically scaling an output from each of the dynamically selected one or more vehicle sensors based on one or more factors, using processor(s) 902.

As further shown in FIG. 11, process 1100 may include, at block 1120, monitoring a forward path of travel of the vehicle for potential collisions, based on data comprising the output from the one or more vehicle sensors. Means for performing the operation of block 1120 may include the processor(s), memory, or transceiver(s) of any of the apparatuses described herein. For example, the vehicle may monitor its forward path of travel using the processor(s) 902, the optional neural network 903, and the sensor(s) 910.

As further shown in FIG. 11, process 1100 may include, at optional block 1130, detecting, based on the data comprising the output from the one or more vehicle sensors, a potential collision of the vehicle with an object in the forward path of travel of the vehicle. Means for performing the operation of block 1130 may include the processor(s), memory, or transceiver(s) of any of the apparatuses described herein. For example, the vehicle may detect a potential collision of the vehicle with an object in a forward path of travel of the vehicle, based on data comprising the dynamically scaled outputs from the one or more dynamically selected vehicle sensors, using the processor(s) 902 and the sensor(s) 910.

As further shown in FIG. 11, process 1100 may include, at optional block 1140, autonomously applying vehicle brakes to avoid the potential collision. Means for performing the operation of block 1140 may include the processor(s), memory, or transceiver(s) of any of the apparatuses described herein. For example, the processor(s) 902 may autonomously apply vehicle brakes to avoid the potential collision, by sending signals through the I/O block 924 to the vehicle braking system 926.

In some aspects, the one or more factors comprise at least one of a vehicle condition, a weather condition, a road or traffic condition, a location of the vehicle, a vehicle sensor capability, a required sensing accuracy, or a change of any of the above.

In some aspects, the vehicle condition comprises at least one of a speed of the vehicle, a direction of travel of the vehicle, an orientation of the vehicle, or a braking status of the vehicle.

In some aspects, the weather condition comprises at least one of a time of day, a location and visibility of the sun, a presence or absence of precipitation, or a presence or absence of clouds, smoke, mist, or fog.

In some aspects, the road or traffic condition comprises at least one of a composition or smoothness of the road surface, a slope or slant of the road surface, a presence or absence of water or ice on the road surface, a presence or absence of barriers, shoulders, or medians, a number of travel lanes, or a presence or absence of other vehicles.

In some aspects, the location of the vehicle comprises at least one of on a road, in a parking lot, in a tunnel, on or under a bridge, or on an off-ramp or on-ramp.

In some aspects, the vehicle sensor capability comprises at least one of a sensor latency, a sensor time-of-flight, a maximum sensor range, a minimum sensor range, a sensor accuracy, or a sensor resolution.

In some aspects, autonomously applying vehicle brakes to avoid the potential collision comprises determining a time to collision (TTC), calculating a braking profile that specifies when and at what strength to apply the vehicle brakes to avoid the potential collision, and autonomously applying the vehicle brakes according to the braking profile.

In some aspects, the braking profile also specifies which of the plurality of vehicle sensors should be considered and at what time during the dynamic selection and scaling steps.

In some aspects, detecting the potential collision of the vehicle with an object in the forward path of travel of the vehicle comprises detecting the potential collision using one or more processors to process the outputs from the dynamically selected and scaled one or more vehicle sensors.

In some aspects, detecting the potential collision of the vehicle with an object in the forward path of travel of the vehicle comprises detecting the potential collision using a neural network to process the outputs from the dynamically selected and scaled one or more vehicle sensors.

In some aspects, the neural network comprises a single layer neural network for each of the one or more dynamically selected vehicle sensors.

In some aspects, the neural network comprises a multiple layer neural network for each of the one or more dynamically selected vehicle sensors.

In some aspects, each multiple-layer neural network is configured to bypass one or more stages based on vehicle conditions.

In some aspects, process 1100 includes receiving an indication that the detection of the potential collision was an AEB false positive, and saving fingerprint information associated with the AEB false positive.

In some aspects, the fingerprint information associated with the AEB false positive comprises at least some of the data upon which the detection of the potential collision was based.

In some aspects, process 1100 includes providing the fingerprint information to a network entity.

In some aspects, process 1100 includes receiving fingerprint information from a network entity, and using the fingerprint information to detect and avoid AEB false positives.

Process 1100 may include additional implementations, such as any single implementation or any combination of implementations described below and/or in connection with one or more other processes described elsewhere herein. Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of autonomous emergency braking (AEB) performed by a vehicle, the method comprising: performing, based on one or more factors, at least one of: dynamically selecting one or more vehicle sensors from a plurality of vehicle sensors, or dynamically scaling an output from one or more selected vehicle sensors; and monitoring a forward path of travel of the vehicle for potential collisions, based on data comprising the output from the one or more dynamically selected and/or scaled vehicle sensors.

Clause 2. The method of clause 1, wherein the one or more factors comprise at least one of: a vehicle condition or location; a vehicle sensor condition, capability, latency, or time-of-flight; a weather condition; a road or traffic condition; a required sensing accuracy; a driver identity, behavior, or condition; or a change of any of the above.

Clause 3. The method of any of clauses 1 to 2, wherein monitoring the forward path of travel of the vehicle for potential collisions comprises using one or more processors to process the outputs from the one or more dynamically selected and/or scaled vehicle sensors.

Clause 4. The method of any of clauses 1 to 3, wherein monitoring the forward path of travel of the vehicle for potential collisions comprises using a neural network to process the outputs from the one or more dynamically selected and/or scaled vehicle sensors.

Clause 5. The method of clause 4, wherein the neural network comprises at least one of: a fully connected layer; a convolutional layer; a deconvolutional layer; or a recurrent layer.

Clause 6. The method of any of clauses 4 to 5, wherein the neural network comprises a single layer neural network for each of the one or more dynamically selected and/or scaled vehicle sensors.

Clause 7. The method of any of clauses 4 to 6, wherein the neural network comprises a multiple layer neural network for each of the one or more dynamically selected and/or scaled vehicle sensors.

Clause 8. The method of clause 7, wherein each multiple-layer neural network is configured to bypass one or more stages based on vehicle conditions.

Clause 9. The method of any of clauses 1 to 8, further comprising: detecting, based on the data comprising the output from the one or more dynamically selected and/or scaled vehicle sensors, a potential collision of the vehicle with an object in the forward path of travel of the vehicle; and autonomously applying vehicle brakes to avoid the potential collision.

Clause 10. The method of clause 9, wherein autonomously applying vehicle brakes to avoid the potential collision comprises: determining a time to collision (TTC); calculating a braking profile that specifies when and at what strength to apply the vehicle brakes to avoid the potential collision; and autonomously applying the vehicle brakes according to the braking profile.

Clause 11. The method of clause 10, wherein the braking profile also specifies which of the plurality of vehicle sensors should be considered and at what time during the dynamic selection and scaling steps.

Clause 12. The method of any of clauses 9 to 11, further comprising: determining that the detection of the potential collision was an AEB false positive; and saving fingerprint information associated with the AEB false positive, wherein the fingerprint information associated with the AEB false positive comprises at least some of the data upon which the detection of the potential collision was based.

Clause 13. The method of clause 12, wherein determining that the detection of the potential collision was an AEB false positive comprises at least one of: receiving, from a driver or occupant of the vehicle, an indication that the detection of the potential collision was an AEB false positive; or determining that the detection of the potential collision was an AEB false positive based on sensor data collected contemporaneously with and/or after the AEB false positive.

Clause 14. The method of any of clauses 12 to 13, further comprising providing the fingerprint information to a network entity.

Clause 15. The method of any of clauses 12 to 14, further comprising receiving fingerprint information from a network entity, and using the fingerprint information to detect and avoid AEB false positives.

Clause 16. An autonomous emergency braking (AEB) system of a vehicle, comprising: a plurality of vehicle sensors; one or more memories; one or more transceivers; and one or more processors communicatively coupled to the one or more memories and the one or more transceivers, the one or more processors, either alone or in combination, configured to: perform, based on one or more factors, at least one of: dynamically selecting one or more vehicle sensors from a plurality of vehicle sensors, or dynamically scaling an output from one or more selected vehicle sensors; and monitor a forward path of travel of the vehicle for potential collisions, based on data comprising the output from the one or more dynamically selected and/or scaled vehicle sensors.

Clause 17. The AEB system of clause 16, wherein the one or more factors comprise at least one of: a vehicle condition or location; a vehicle sensor condition, capability, latency, or time-of-flight; a weather condition; a road or traffic condition; a required sensing accuracy; a driver identity, behavior, or condition; or a change of any of the above.

Clause 18. The AEB system of any of clauses 16 to 17, wherein, to monitor the forward path of travel of the vehicle for potential collisions, the one or more processors, either alone or in combination, are configured to process the outputs from the one or more dynamically selected and/or scaled vehicle sensors.

Clause 19. The AEB system of any of clauses 16 to 18, wherein, to monitor the forward path of travel of the vehicle for potential collisions, the one or more processors, either alone or in combination, are configured to use a neural network to process the outputs from the one or more dynamically selected and/or scaled vehicle sensors.

Clause 20. The AEB system of clause 19, wherein the neural network comprises at least one of: a fully connected layer; a convolutional layer; a deconvolutional layer; or a recurrent layer.

Clause 21. The AEB system of any of clauses 19 to 20, wherein the neural network comprises a single layer neural network for each of the one or more dynamically selected and/or scaled vehicle sensors.

Clause 22. The AEB system of any of clauses 19 to 21, wherein the neural network comprises a multiple layer neural network for each of the one or more dynamically selected and/or scaled vehicle sensors.

Clause 23. The AEB system of clause 22, wherein each multiple-layer neural network is configured to bypass one or more stages based on vehicle conditions.

Clause 24. The AEB system of any of clauses 16 to 23, wherein the one or more processors, either alone or in combination, are further configured to: detect, based on the data comprising the output from the one or more dynamically selected and/or scaled vehicle sensors, a potential collision of the vehicle with an object in the forward path of travel of the vehicle; and autonomously apply vehicle brakes to avoid the potential collision.

Clause 25. The AEB system of clause 24, wherein the one or more processors configured to autonomously apply vehicle brakes to avoid the potential collision comprises the one or more processors, either alone or in combination, configured to: determine a time to collision (TTC); calculate a braking profile that specifies when and at what strength to apply the vehicle brakes to avoid the potential collision; and autonomously apply the vehicle brakes according to the braking profile.

Clause 26. The AEB system of clause 25, wherein the braking profile also specifies which of the plurality of vehicle sensors should be considered and at what time during the dynamic selection and scaling steps.

Clause 27. The AEB system of any of clauses 24 to 26, wherein the one or more processors, either alone or in combination, are further configured to: determine that the detection of the potential collision was an AEB false positive; and save fingerprint information associated with the AEB false positive, wherein the fingerprint information associated with the AEB false positive comprises at least some of the data upon which the detection of the potential collision was based.

Clause 28. The AEB system of clause 27, wherein, to determine that the detection of the potential collision was an AEB false positive, the one or more processors are configured to at least one of: receive, from a driver or occupant of the vehicle, an indication that the detection of the potential collision was an AEB false positive; or determine that the detection of the potential collision was an AEB false positive based on sensor data collected contemporaneously with and/or after the AEB false positive.

Clause 29. The AEB system of any of clauses 27 to 28, wherein the one or more processors are further configured to provide the fingerprint information to a network entity.

Clause 30. The AEB system of any of clauses 27 to 29, wherein the one or more processors are further configured to receive fingerprint information from a network entity and use the fingerprint information to detect and avoid AEB false positives.

Clause 31. An apparatus comprising a memory, a transceiver, and a processor communicatively coupled to the memory and the transceiver, the memory, the transceiver, and the processor configured to perform a method according to any of clauses 1 to 30.

Clause 32. An apparatus comprising means for performing a method according to any of clauses 1 to 30.

Clause 33. A non-transitory computer-readable medium storing computer-executable instructions, the computer-executable comprising at least one instruction for causing a computer or processor to perform a method according to any of clauses 1 to 30.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field programmable gate array (FPGA), or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., a user equipment (UE)). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of autonomous emergency braking (AEB) performed by a vehicle, the method comprising:
performing, based on one or more factors, at least one of:
dynamically selecting one or more vehicle sensors from a plurality of vehicle sensors, or
dynamically scaling an output from one or more selected vehicle sensors; and
monitoring a forward path of travel of the vehicle for potential collisions, based on data comprising the output from the one or more dynamically selected and/or scaled vehicle sensors.

2. The method of claim 1, wherein the one or more factors comprise at least one of:
a vehicle condition or location;
a vehicle sensor condition, capability, latency, or time-of-flight;
a weather condition;
a road or traffic condition;
a required sensing accuracy;
a driver identity, behavior, or condition; or
a change of any of the above.

3. The method of claim 1, wherein monitoring the forward path of travel of the vehicle for potential collisions comprises using one or more processors to process the outputs from the one or more dynamically selected and/or scaled vehicle sensors.

4. The method of claim 1, wherein monitoring the forward path of travel of the vehicle for potential collisions comprises using a neural network to process the outputs from the one or more dynamically selected and/or scaled vehicle sensors.

5. The method of claim 4, wherein the neural network comprises at least one of:
a fully connected layer;
a convolutional layer;
a deconvolutional layer; or
a recurrent layer.

6. The method of claim 4, wherein the neural network comprises a single layer neural network for each of the one or more dynamically selected and/or scaled vehicle sensors.

7. The method of claim 4, wherein the neural network comprises a multiple layer neural network for each of the one or more dynamically selected and/or scaled vehicle sensors.

8. The method of claim 7, wherein each multiple-layer neural network is configured to bypass one or more stages based on vehicle conditions.

9. The method of claim 1, further comprising:
detecting, based on the data comprising the output from the one or more dynamically selected and/or scaled vehicle sensors, a potential collision of the vehicle with an object in the forward path of travel of the vehicle; and
autonomously applying vehicle brakes to avoid the potential collision.

10. The method of claim 9, wherein autonomously applying vehicle brakes to avoid the potential collision comprises:
determining a time to collision (TTC);
calculating a braking profile that specifies when and at what strength to apply the vehicle brakes to avoid the potential collision; and
autonomously applying the vehicle brakes according to the braking profile.

11. The method of claim 10, wherein the braking profile also specifies which of the plurality of vehicle sensors should be considered and at what time during the dynamic selection and scaling steps.

12. The method of claim 9, further comprising:
determining that the detection of the potential collision was an AEB false positive; and
saving fingerprint information associated with the AEB false positive, wherein the fingerprint information associated with the AEB false positive comprises at least some of the data upon which the detection of the potential collision was based.

13. The method of claim 12, wherein determining that the detection of the potential collision was an AEB false positive comprises at least one of:
receiving, from a driver or occupant of the vehicle, an indication that the detection of the potential collision was an AEB false positive; or
determining that the detection of the potential collision was an AEB false positive based on sensor data collected at a time of and/or after the AEB false positive.

14. The method of claim 12, further comprising providing the fingerprint information to a network entity.

15. The method of claim 12, further comprising receiving fingerprint information from a network entity, and using the fingerprint information to detect and avoid AEB false positives.

16. An autonomous emergency braking (AEB) system of a vehicle, comprising:
a plurality of vehicle sensors;
one or more memories;
one or more transceivers; and
one or more processors communicatively coupled to the one or more memories and the one or more transceivers, the one or more processors, either alone or in combination, configured to:
perform, based on one or more factors, at least one of:
dynamically selecting one or more vehicle sensors from the plurality of vehicle sensors, or
dynamically scaling an output from one or more selected vehicle sensors; and
monitor a forward path of travel of the vehicle for potential collisions, based on data comprising the output from the one or more dynamically selected and/or scaled vehicle sensors.

17. The AEB system of claim 16, wherein the one or more processors, either alone or in combination, are further configured to:
detect, based on the data comprising the output from the one or more dynamically selected and/or scaled vehicle sensors, a potential collision of the vehicle with an object in the forward path of travel of the vehicle; and
autonomously apply vehicle brakes to avoid the potential collision.

18. The AEB system of claim 17, wherein the one or more processors configured to autonomously apply vehicle brakes to avoid the potential collision comprises the one or more processors, either alone or in combination, configured to:
determine a time to collision (TTC);
calculate a braking profile that specifies when and at what strength to apply the vehicle brakes to avoid the potential collision; and
autonomously apply the vehicle brakes according to the braking profile.

19. The AEB system of claim 17, wherein the one or more processors configured to detect the potential collision of the vehicle with an object in the forward path of travel of the vehicle comprises the one or more processors, either alone or in combination, configured to detect the potential collision using a neural network to process the outputs from the one or more dynamically selected and/or scaled vehicle sensors.

20. The AEB system of claim 17, wherein the one or more processors, either alone or in combination, are further configured to:
determine that the detection of the potential collision was an AEB false positive; and
save fingerprint information associated with the AEB false positive, wherein the fingerprint information associated with the AEB false positive comprises at least some of the data upon which the detection of the potential collision was based.
